(19) United States
(12) Patent Application Publication
(10) Pub. No.: US 2012/0175960 A1
(43) Pub. Date: Jul. 12, 2012

(54) Battery Management System and Method

(76) Inventor: Robert Winkelman, Fayetteville, AR (US)

(21) Appl. No.: 13/365,686

(22) Filed: Feb. 3, 2012

Related U.S. Application Data
(62) Division of application No. 12/423,512, filed on Apr. 14, 2009.

(51) Int. Cl. H02J 1/00

(52) U.S. Cl. 307/77

(57) ABSTRACT

A battery management system for use in multi-battery and/or multi-cell applications, including a wiring harness for connecting a plurality of batteries in an order having at least two end positions and at least one interior position, with each position being initially occupied by one of the batteries, and an interconnection mechanism connected to the harness and configured to modify the positions occupied by the batteries. The mechanism may be configured to measure a voltage of each battery and modify the positions when a voltage difference is detected. Alternatively, the mechanism may be configured to modify the positions each time a voltage drop is detected. The order may further comprise at least one out-of-service position, with the mechanism being configured to modify the positions such that the battery in the out-of-service position and at least one of the batteries in one of the end positions are reconnected to exchange positions.

### CROSS REFERENCE TO RELATED APPLICATIONS

This application is a divisional of, and claims priority benefit of, U.S. patent application Ser. No. 12/423,512, filed Apr. 14, 2009, entitled “Battery Management System”, the entire disclosure of which is incorporated herein by specific reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to battery management systems; and more specifically related to a battery management and reconfigurable interconnection system for use in multi-battery applications.

2. Description of the Related Art

Electric vehicles, as well as other loads, often employ multi-battery banks. Such banks are typically connected in series, thereby producing a higher voltage than any one battery can produce by itself. However, wiring batteries in series often presents problems.

The inventions disclosed and taught herein are directed to an improved battery management and reconfigurable interconnection system for use in multi-battery applications.

### BRIEF SUMMARY OF THE INVENTION

The present invention is a battery management system for use in multi-battery and/or multi-cell applications. In one embodiment, the system comprises a wiring harness for connecting a plurality of batteries, or cells, in an order having at least two end positions and at least one interior position, with each position being initially occupied by one of the batteries, and an interconnection mechanism, or interconnector, connected to the harness and configured to modify the positions occupied by the batteries. The interconnector may be configured to modify the positions such that at least one of the batteries occupying one of the end positions is reconnected to occupy one of the interior positions. Simultaneously, at least one of the batteries occupying one of the interior positions may be reconnected to occupy one of the end positions. For example, in an embodiment where the order comprises an anode position, the interior position, and a cathode position, the interconnector may be configured to modify the positions such that the battery in the anode position is reconnected to the interior position. Alternatively, or additionally, the battery in the cathode position may be reconnected to the interior position. The order may further comprise at least one out-of-service position, with the interconnector being configured to modify the positions such that the battery in the out-of-service position is reconnected to one of the in-service positions, such as one of the end positions or interior positions. The interconnector may be configured to measure a voltage of each battery and modify the positions when a voltage difference is detected. Alternatively, the interconnector may be configured to modify the positions each time a voltage reduction is detected.

### BRIEF DESCRIPTION OF THE SEVERAL VIEWS OF THE DRAWINGS

FIG. 1 illustrates a particular embodiment of a battery management system utilizing certain aspects of the present inventions;

FIG. 2 illustrates a flow chart depicting certain aspects of the present inventions;

FIG. 3 illustrates a modified state of the battery management system utilizing certain aspects of the present inventions;

FIG. 4 illustrates another modified state of the battery management system utilizing certain aspects of the present inventions;

FIG. 5 illustrates a second particular embodiment of the battery management system utilizing certain aspects of the present inventions;

FIG. 6 illustrates a modified state of the second embodiment of the battery management system utilizing certain aspects of the present inventions;

FIG. 7 illustrates another modified state of the second embodiment of the battery management system utilizing certain aspects of the present inventions;

FIG. 8 illustrates a third particular embodiment of the battery management system utilizing certain aspects of the present inventions;

FIG. 9 illustrates another flow chart depicting certain aspects of the present inventions; and

FIG. 10 illustrates a modified state of the third embodiment of the battery management system utilizing certain aspects of the present inventions.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Applicants have created a battery management system for use in multi-battery and/or multi-cell applications. In one embodiment, the system comprises a wiring harness for connecting a plurality of batteries, or cells, in an order having at least two end positions and at least one interior position, with each position being initially occupied by one of the batteries, and an interconnection mechanism, or interconnector, connected to the harness and configured to modify the positions occupied by the batteries. The interconnector may be configured to modify the positions such that at least one of the batteries occupying one of the end positions is reconnected to occupy one of the interior positions. Simultaneously, at least one of the batteries occupying one of the interior positions may be reconnected to occupy one of the end positions. For example, in an embodiment where the order comprises an anode position, the interior position, and a cathode position, the interconnector may be configured to modify the positions such that the battery in the anode position is reconnected to the interior position. Alternatively, or additionally, the battery in the cathode position may be reconnected to the interior position. The order may further comprise at least one out-of-service position, with the interconnector being configured to modify the positions such that the battery in the out-of-service position is reconnected to one of the in-service positions, such as one of the end positions or interior positions. The interconnector may be configured to measure a voltage of each battery and modify the positions when a voltage difference is detected. Alternatively, the interconnector may be configured to modify the positions each time a voltage reduction is detected.

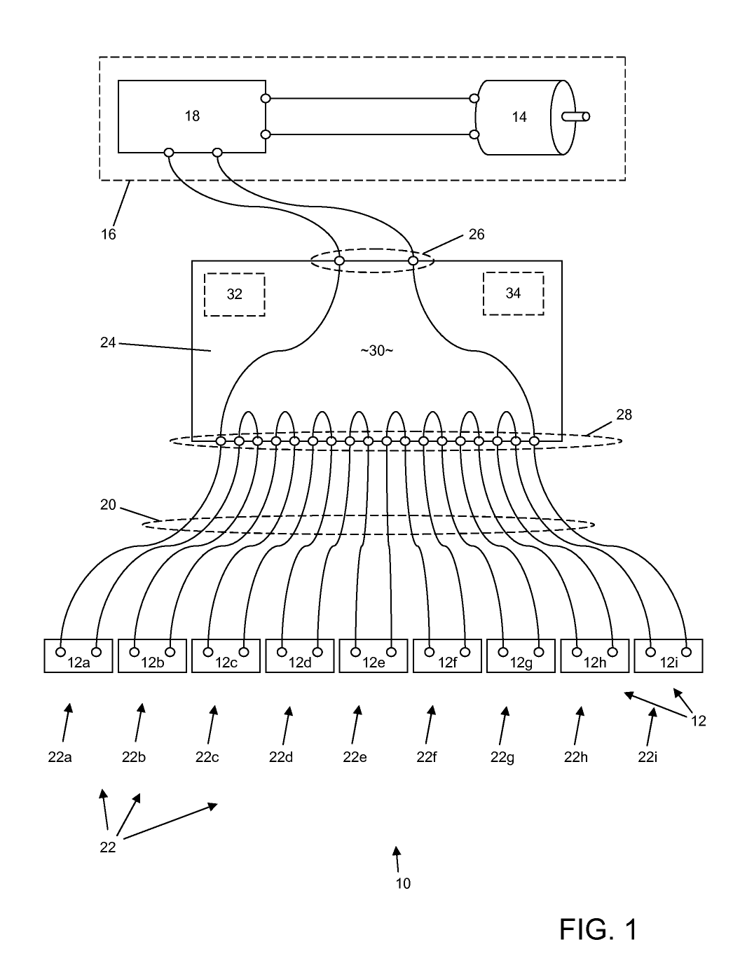

FIG. 1 is an illustration of a battery management system 10 for use in multi-battery applications. For example, the system 10 of the present invention may be used to charge and/or supply direct current (DC) power from a plurality of batteries 12, or individual cells, to a motor 14 and/or other components of an electric vehicle 16, or other load. As such, the system 10 may provide the DC power directly, or indirectly through a control system 18. In the case of an electric vehicle, the system 10 and batteries 12 may be mounted on or within the vehicle.

In one embodiment, the system 10 includes one or more wiring harnesses 20 for connecting the batteries 12 to the motor, or other load, 14. The batteries 12 may be arranged in one or more banks, as will be discussed in greater detail below. The batteries 12 are preferably connected in a series configuration, or order. Thus, two of the batteries 12 will be in anode or cathode end positions 22a,22i with the remaining batteries in interior positions 22b-22h.

The system 10 also comprises an interconnection mechanism, or interconnector, 24 connected between the load 14 and the harness 20 and configured to modify the order of or positions 22a-22i occupied by the batteries 12. As such, the mechanism 24 preferably includes a plurality of output terminals 26, input terminals 28, and one or more interconnections 30. As shown, the output terminals 26 may be connected, directly or indirectly, to the load 14. The input terminals 28 may be connected to the harness 20 or the batteries 12 directly. The interconnections 30 are reconfigurable to connect one or more output terminals 26 and/or input terminals 28. More specifically, the interconnections 30 may connect any output terminal 26 to any input terminal 28. The interconnections 30 may also connect any input terminal 28 to any other input terminal 28.

The interconnections 30 may include mechanical devices, such as relays, contactors, stepping switches, and/or rotary switches. Alternatively, the interconnections 30 may include solid state devices, such as thyristors, bidirectional triode thyristors, bipolar junction transistors, field effect transistors, and/or another type of silicon controlled rectifier. Additionally, the interconnections 30 may include some combination of the above devices. In one embodiment, the interconnections 30 are embodied by a series of stepping switches and jumper wires.

In some embodiments, the mechanism 24 also includes a voltage detector, or voltage detection device, 32 connectable to the output terminals 26 and/or the input terminals 28, and/or a controller 34 to control the interconnections 30. As will be discussed in greater detail below, the controller 34 may use the voltage detector 32 to determine when to shift the positions 22a-22i using the interconnections 30. In one embodiment, the voltage detector 32 is integrated into the controller 34. In another embodiment, the controller 34 simply shifts the positions 22a-22i according to a predetermined elapsed time period.

In use, according to one particular embodiment, the system 10 controls the positions 22a-22i of the batteries 12a-12i using the harness 20 and the mechanism 24. For example, the system 10 may start with each one of the batteries 12a-12i initially occupying one of the positions 22a-22i through the interconnections 30 as shown in FIG. 1. It can be seen that a first battery 12a is occupying a first position 22a, which is an end position. Similarly, a ninth battery 12i is occupying a ninth position 22i, which is also an end position. These end positions 22a,22i may be an anode position or a cathode position with regard to the bank of batteries 12,12a-12i, depending on the polarity of the bank and/or harness 20. The remaining batteries 12b-12h are occupying interior positions 22b-22h, respectively.

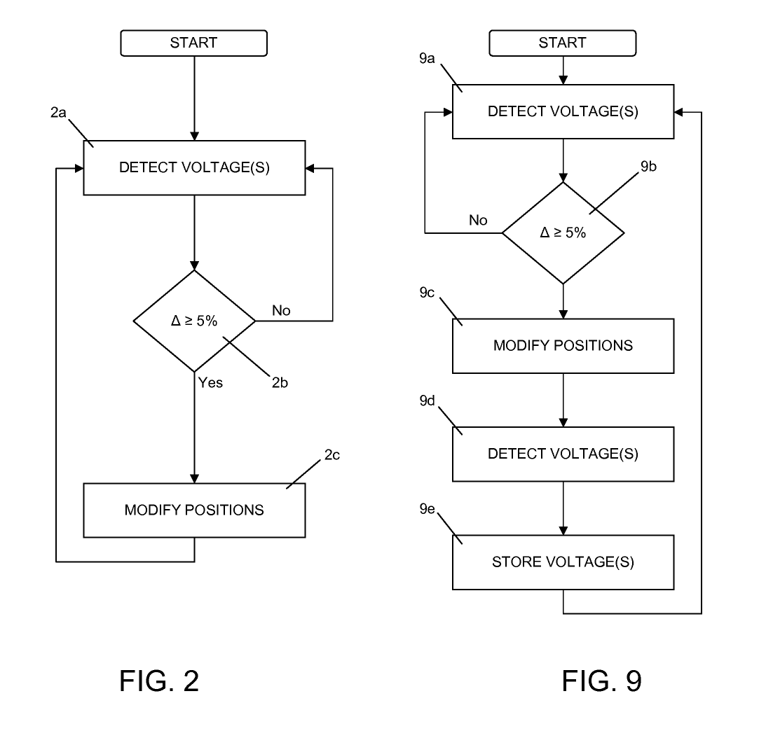

Referring also to FIG. 2, the system 10 senses, or detects, the voltages of the batteries 12, as shown in step 2a. More particularly, in one embodiment, the controller 34 detects the voltage of each battery 12 at the input terminals 28 using the voltage detector 32. The controller 34 and/or the voltage detector 32 may also determine, or calculate, an average, median, or mean voltage as well. Alternatively, the controller 34 and/or the voltage detector 32 may take a voltage measurement at the output terminals 26, divide by the number of batteries in-service, and use the result as the average voltage, as will be discussed in further detail below.

The system 10 then determines if there is a voltage difference between the batteries 12, as shown in step 2b. More specifically, in one embodiment, the controller 34 compares the voltages of each battery 12a-12i. If one or more of the batteries 12 are at, within, or more than a predetermined voltage difference with respect to one or more of the other batteries 12, or the average, median, or mean voltage, then the system 10 modifies the positions 22a-22i occupied by one or more of the batteries 12a-12i, as shown in step 2c.

The predetermined voltage difference may be a range of voltages, such as between one percent and ten percent or between four percent and five percent. Alternatively, the system 10 may look for a set predetermined voltage drop, such as four percent, 4.7 percent, or five percent. In one embodiment, the system 10 shifts the positions 22a-22i at a set predetermined voltage difference of approximately five percent. The voltage difference may be between individual batteries 12, may be between the highest voltage battery and the lowest voltage battery, or may be referenced to the average, median, or mean battery voltage.

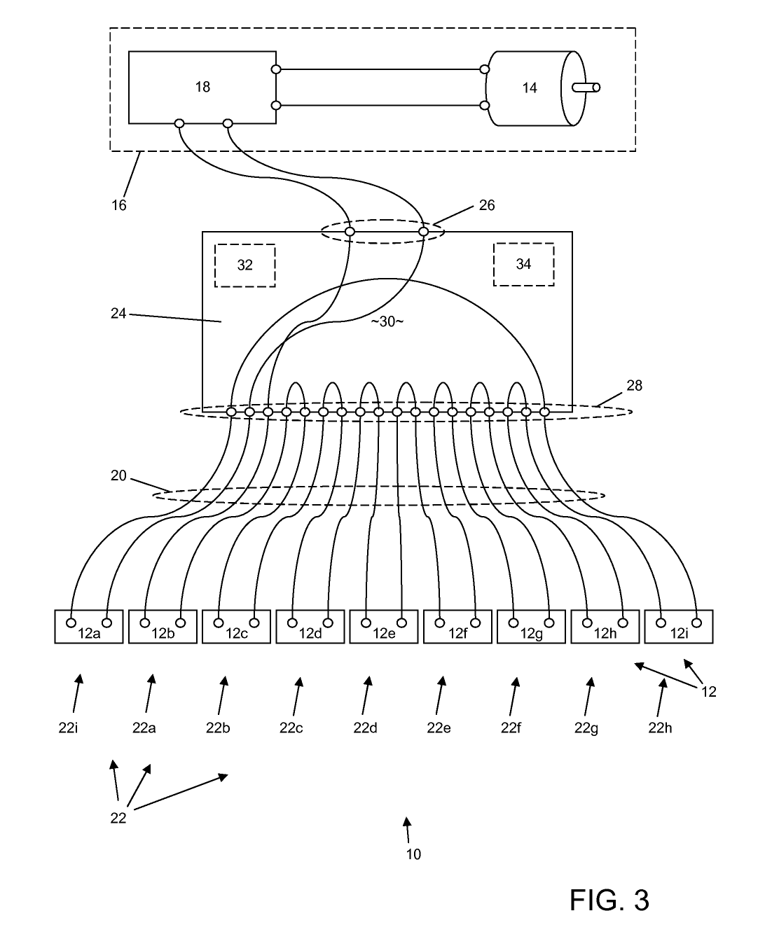

As shown in FIG. 3, the system 10 modifies, or shifts, the positions 22a-22i using the interconnections 30 of the mechanism 24, after or upon detection of the voltage difference. For example, as shown, a second battery 12b takes the place of the first battery 12a, in the first position 22a. Thus, the second battery 12b, which was initially in an interior position 22b, is now in an end position 22a. Likewise, the ninth battery 12i, which was initially in an end position 22i, is now in an interior position 22h. Here, the first battery 12a, which was in the first position 22a, is now in the ninth position 22i, which is still an end position. Thus, the first battery 12a changes from an anode position to a cathode position, or visa versa depending on the polarity of the bank and/or the harness 20. The remaining batteries 12c-12h remain in interior positions.

It has been discovered that batteries in end positions of the serial string, or order, often experience more significant voltage drop than do batteries in interior positions of the string. These batteries also take the brunt of the negative effects of charging and discharging, and as such may inhibit a bank from fully charging or discharging. By modifying, shifting, or rotating the order, as described above, batteries in end positions may be reconnected to interior positions, and vise versa, thereby sharing the more significant voltage drop, and other negative effects, experienced in end positions across the entire battery bank.

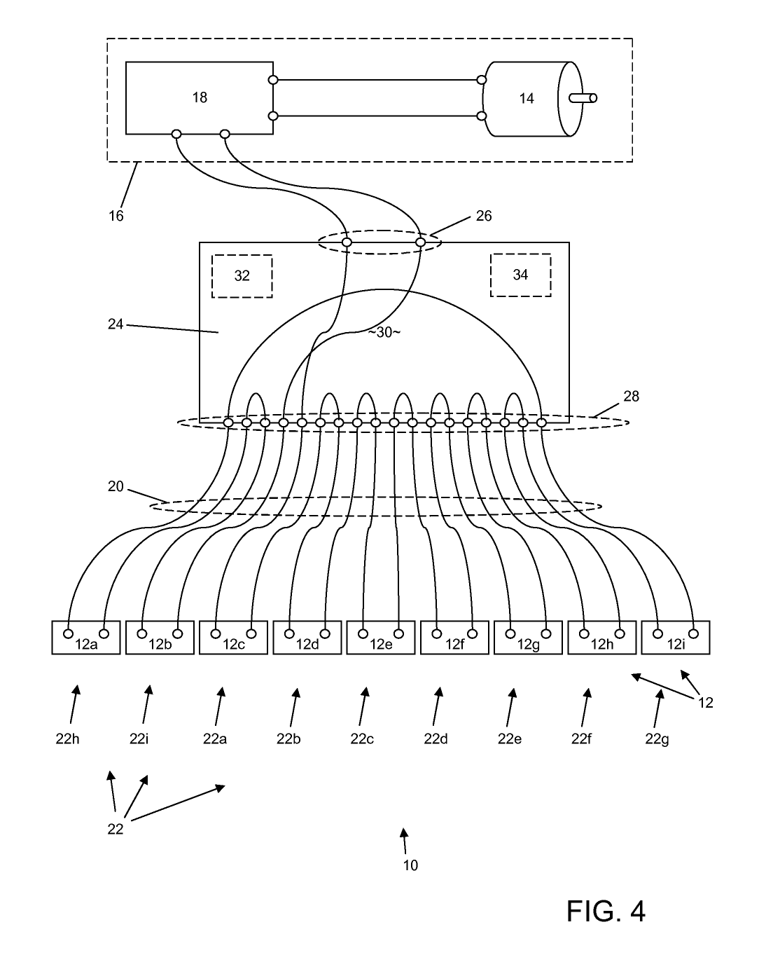

In keeping with the above, it can be seen that with just one shift, at least one battery, such as the first battery 12a, may remain in an end position, albeit the opposite end position. Therefore, the system 10 may perform two or more shifts at the same time. For example, the system 10 may perform two shifts at a time, such that the system 10 shifts from the configuration shown in FIG. 1 to the configuration shown in FIG. 4 upon detection of the voltage difference, voltage reduction, or expiration of the time period. As shown in FIG. 4, the first battery 12a, which was in the first position 22a (an end position), is now in the eighth position 22h, which is an interior position. Likewise, the ninth battery 12i, which was in the ninth position 22i (an end position), is now in a seventh position 22g, which is an interior position. The second and third batteries 12b,12c, which were in the second and third positions 22b,22c (interior positions), are now in the ninth and first positions 22i,22a, respectively, which are end positions. In this manner, the system 10 of the present invention can shift the batteries in end positions to interior positions, thereby sharing the voltage drop experienced in end positions across the entire battery bank.

One can appreciate, upon reading this disclosure, that the system 10 may continue to monitor the voltages and conduct additional shifts the next time the voltage difference, or drop, is detected. Alternatively, rather than an additional shift, the system 10 may shift back to the initial configuration the next time the voltage difference, or reduction, is detected. Additionally, the system 10 may shift the positions 12 in the opposite direction. Furthermore, rather than rotating positions in the above described linear fashion, the system may modify the positions in other manners. For example, the system 10 may shift the positions 12 in a random manner. Alternatively, the batteries 12 in the end positions 22a,22i may be reconnected more toward the center of the order, shifting batteries inwardly and/or outwardly. Furthermore, the system 10 may exchange the positions of individual batteries 12. Finally, the system 10 may use different techniques each time a position modification is desired.

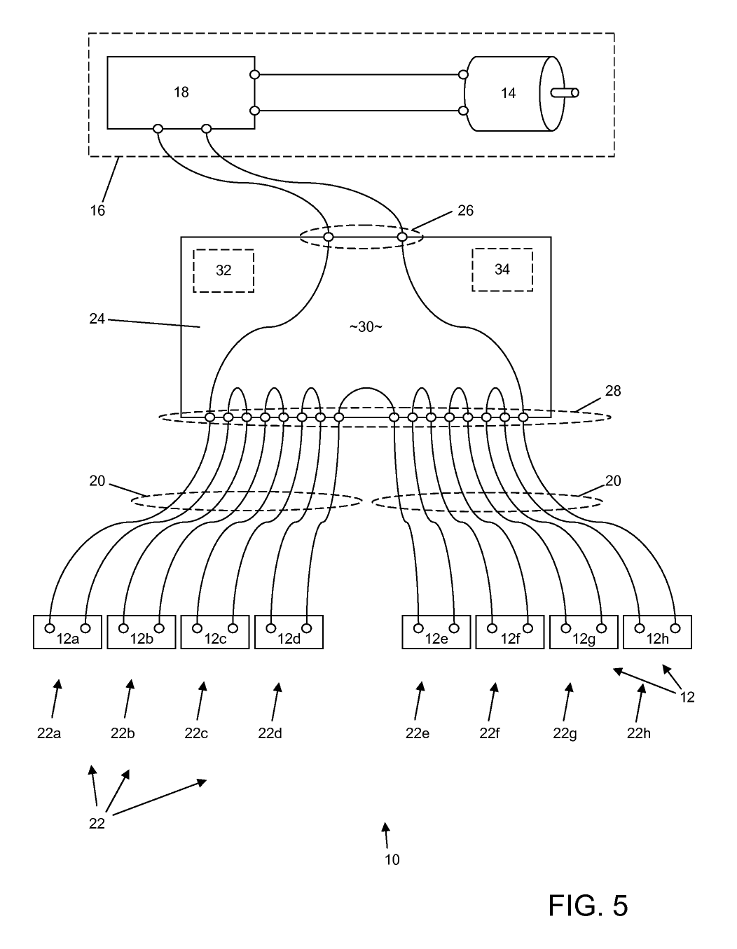

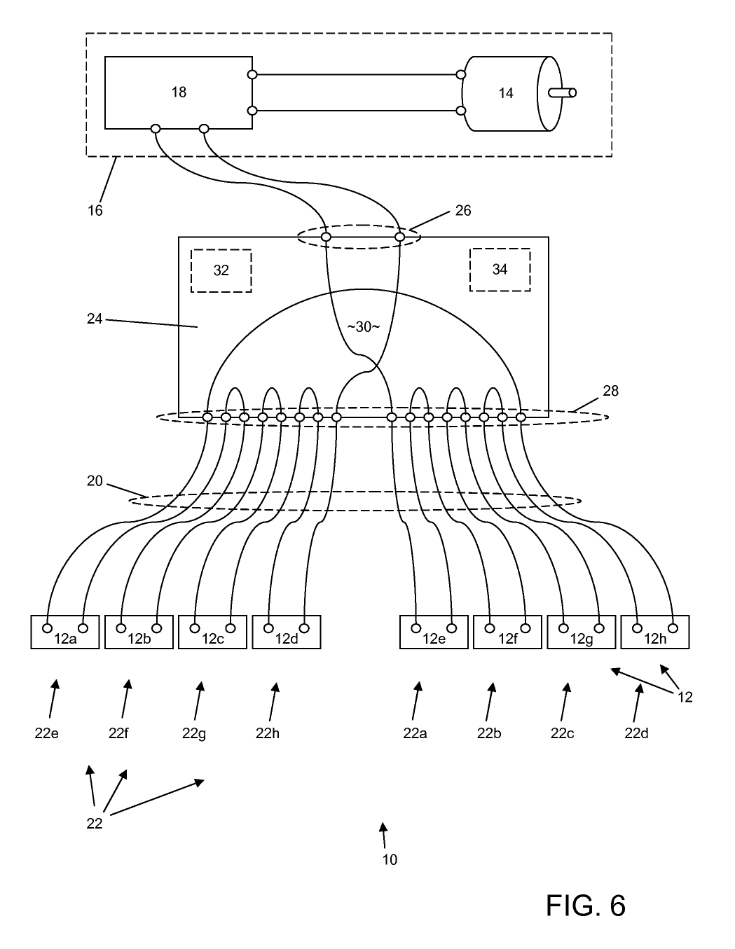

In another embodiment, referring to FIG. 5 and FIG. 6, the system 10 may comprise an even number of batteries 12 configured into two or more sub-banks 12a-12d,12e-12h. As shown, the harness 20 may actually comprise two or more harnesses, thereby allowing the batteries 12, or banks, to be located remotely from each other. In any case, the system 10 may swap the batteries 12a,12h initially in the first and eighth positions 22a,22h, both end positions, with the batteries 12e,12d initially in central interior positions 22e,22d. This exchange also swaps each sub-bank of batteries 12a-12d,12e-12h between anode/cathode positions (22a-22d),(22e-22h).

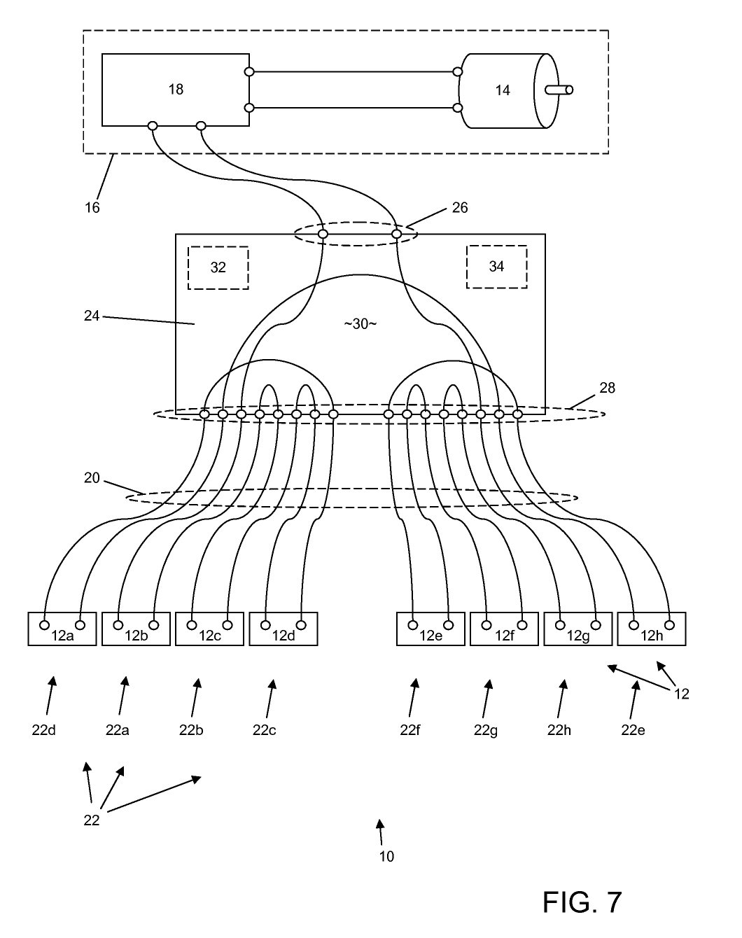

Alternatively, referring to FIG. 5 and FIG. 7, the system 10 may rotate the batteries 12a,12h initially in the first and eighth positions 22a,22h, both end positions, into interior positions 22d,22e. This exchange retains each sub-bank of batteries 12a-12d,12e-12f in their anode/cathode positions (22a-22d),(22e-22h), while rotating the batteries 12 in each sub-bank of batteries 12a-12d,12e-12h. As discussed above, modifying the positions 22a-22h of the batteries 12a-12h may be conducted one or more steps at a time, each time a voltage difference, or reduction, is detected, in the opposite direction, inwardly, outwardly, and/or randomly.

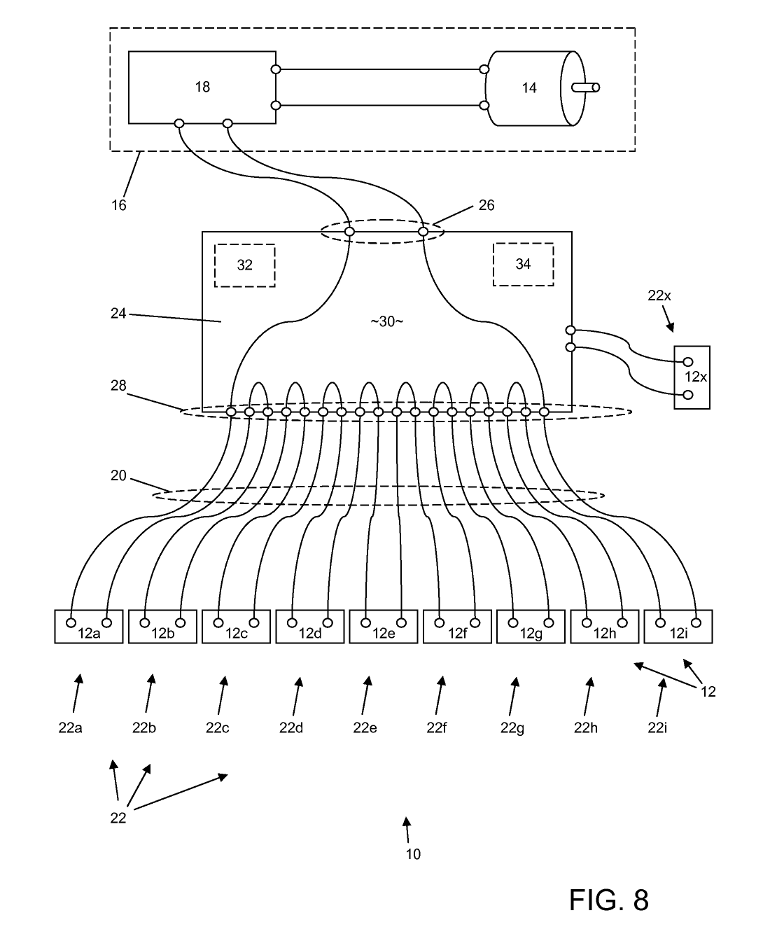

As shown in FIG. 8, the system 10 may include one or more spare batteries 12x in one or more out-of-service positions 22x. More specifically, the mechanism 24 may place an initially out-of-service battery 12x into service, taking one of the in-service positions 22a-22i, by reconfiguring the interconnections 30. These out-of-service batteries 12x may be used to replace other batteries 12 that have experienced some failure or otherwise have become temporarily or permanently unserviceable. Alternatively, or additionally, the out-of-service battery 12x may be undergoing a charge cycle, while in the out-of-service position 12x.

Furthermore, the out-of-service battery(s) 12x may be used to take advantage of a phenomena known as battery bounce. More specifically, it has been discovered that removing a load from a battery for a period of time actually allows the battery to recover some charge, or voltage, such as by reabsorbing a static charge. Thus, by placing one or more in-service batteries 12 in the out-of-service position 22x, those batteries 12 may recover some charge and then be placed back in-service, thereby taking advantage battery bounce.

The system 10 may therefore periodically swap the batteries 12 in the in-service positions 22a-22i with the batteries 12 in the one or more out-of-service positions 22x. Alternatively, the system 10 may use any individual battery voltage(s), or the average, median, or mean battery voltage discussed above, to determine when to swap the batteries 12 in the in-service positions 22a-22i with the batteries 12 in the one or more out-of-service positions 22x.

For example, referring also to FIG. 9, the system 10 senses, or detects, the voltages of the batteries 12, as shown in step 9a. The system 10 then compare the average battery voltage to a previously stored value. More specifically, the system 10, or simply the controller 34, determines whether there has been a voltage reduction, as shown in step 9b. For example, the system 10 may look for a predetermined voltage reduction within a range, such as between one percent and ten percent or between four percent and five percent. Alternatively, the system 10 may look for a set predetermined voltage reduction, such as four percent, 4.7 percent, or five percent. Once, when, or after the system 10 detects the voltage reduction, the system 10 may swap, rotate, shift, or exchange one or more of the batteries 12 in the in-service positions 22a-22i with the battery(s) 12x in the one or more out-of-service positions 22x, or otherwise incorporate the battery(s) 12x in the one or more out-of-service positions 22x, as shown in step 9c.

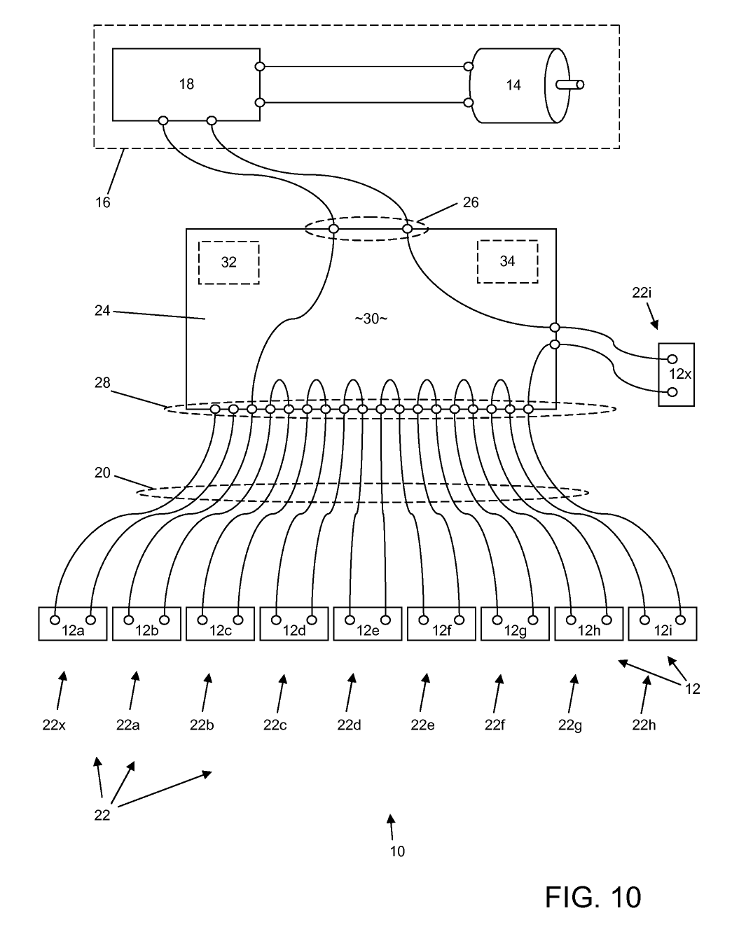

More specifically, referring also to FIG. 10, the order, or positions 22 may be modified or shifted to place one of the batteries 12a that was initially in one of the in-service positions 22a in the out-of-service position 22x. Additionally, the battery 12x initially in the out-of-service position 22x is now in one of the in-service positions, such as end position 22i. Furthermore, it can be seen that the batteries 12a,12i that were initially in end positions 22a,22i, are now in the out-of-service position and/or one of the interior positions 12h, thereby also completely accounting for the end position voltage drop issue discussed above, with only one order or position shift.

The system 10 may also sense or otherwise detect a new average, median, or mean battery voltage, as shown in step 9d, and store that new voltage in a memory internal or external to the controller 34, mechanism 24, or system 10, as shown in step 2h. At this point, as well as after step 2c of FIG. 2, the system 10 preferably reiterates the process, as shown. It can also be seen that after finding little or no voltage difference, or reduction, in steps 2b and 9b, the process preferably reiterates. The processes described in FIG. 2 and FIG. 9 may run substantially continuously, periodically, and/or be triggered by a user or other outside influence. Additionally, the processes described in FIG. 2 and FIG. 9 may run serially, one after the other, and/or parallel, or concurrently.

The system 10 of the present invention, as described above, may be used with banks of batteries 12 ranging from between three and twenty batteries. In one preferred embodiment, the banks of batteries 12 preferably comprises eight in-service batteries with one out-of-service battery. In any case, as discussed above, the batteries 12 may be arranged in one or more banks which may be distributed among one or more locations.

Furthermore, while the system 10 has been described as being used with banks of batteries 12, the system 10 of the present invention may also be used with individual cells of one or more batteries 12. For example, rather than merely switching the order or positions of the batteries 12, the system 10 of the present invention may alternatively, or additionally, switch the order or positions of individual cells within one or more of the batteries 12.

In any case, the system 10 of the present invention provides for more uniform charging and/or discharging of the cells of the batteries 12, and/or batteries 12 themselves. For example, rather than more rapidly charging/discharging the anode and cathode batteries, the system 10 of the present invention allows the order or positions of the batteries or cells to be modified, such that different batteries or cells are placed in the anode and cathode positions, such as during charging and/or discharging, thereby uniformly charging and/or discharging the cells and/or batteries.

This uniform charging and/or discharging is one of the reasons the system 10 of the present invention may increase the life-cycle and/or reserve capacity of a battery, or bank of batteries 12, by as much as 6-9%, without requiring any changes to the production or manufacturing processes of the batteries, or the batteries themselves. This, in turn, makes it possible to dramatically increase the utility of a battery, or bank of batteries. For example, the uniform charging of the present invention increases the amount of power that may be stored in a battery, or bank of batteries, thereby dramatically increasing the effect of green power sources, such as solar, wind generation, and manual or human driven alternators or generators, as well as more traditional power sources.

Additionally, the system 10 of the present invention may be used to help power utilities and/or their customers better manage or balance demand. For example, the system 10 of the present invention may be used in homes and/or business, such as part of an uninterruptible power supply (UPS), to supply power during an outage or high demand, or cost, period. More specifically, the system 10 of the present invention may be used to charge cells and/or batteries during availability of lower cost power, such as at night, and then supply power to the homes and/or businesses when utility power is unavailable or priced at a higher rate, such as during peak demand.

Other and further embodiments utilizing one or more aspects of the inventions described above can be devised without departing from the spirit of Applicant's invention. For example, rather than having one out-of-service battery 12x, the system 10 may include multiple out-of-service batteries, and even an entire out-of-service bank of batteries. In this case, the system 10 could switch between banks to accommodate the battery bounce phenomena discussed above. Further, the various methods and embodiments of the present invention can be included in combination with each other to produce variations of the disclosed methods and embodiments. For example, rather than being two separate components, the mechanism 24 may be built into the harness 20. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method for managing a bank of batteries, comprising the steps of:
electrically coupling a plurality of batteries in series, forming the bank of batteries, such that—
a first battery is electrically coupled in an anode end position of the bank,
a second battery is electrically coupled in a cathode end position of the bank, and
at least a third battery is electrically coupled in at least one middle position of the bank;
determining an anode voltage, wherein the anode voltage is determined by measuring across the battery in the anode end position;
determining a reference voltage, wherein the reference voltage is determined by measuring across the battery in the at least one middle position;
comparing the anode voltage with the reference voltage; and
electrically rearranging, if a first difference between the anode voltage and the reference voltage is more than a predetermined amount, the batteries such that the first battery is no longer electrically coupled in the anode end position of the bank.

2. The method of claim 1, further including the steps of:
determining a cathode voltage, wherein the cathode voltage is determined by measuring across the battery in the cathode end position;
comparing the cathode voltage with the reference voltage; and
electrically rearranging, if a second difference between the cathode voltage and the reference voltage is more than a predetermined amount, the batteries such that the second battery is no longer electrically coupled in the cathode end position of the bank.

3. The method of claim 1, wherein the electrically rearranging step comprises electrically coupling the plurality of batteries in series in a modified order, without changing a physical relationship of the batteries.

4. The method of claim 1, wherein the electrically rearranging step comprises electrically coupling the plurality of batteries in series such that—
the third battery is electrically coupled in the anode end position of the bank,
the first battery is electrically coupled in the cathode end position of the bank, and
the second battery is electrically coupled in the middle position of the bank;

5. The method of claim 1, wherein the electrically rearranging step comprises electrically coupling the plurality of batteries in series such that—
the second battery is electrically coupled in the anode end position of the bank,
the third battery is electrically coupled in the cathode end position of the bank, and
the first battery is electrically coupled in the middle position of the bank;

6. The method of claim 1, wherein determining the reference voltage comprises measuring across each of a plurality of batteries in middle positions of the bank and averaging these measured voltages.

7. The method of claim 1, wherein the determining steps are performed periodically.

8. The method of claim 1, wherein the determining steps are performed when a voltage reduction across the bank is detected.

9. The method of claim 1, wherein the electrically rearranging step comprises electrically removing the first battery from the bank.

10. The method of claim 1, wherein the electrically rearranging step comprises electrically coupling a fourth battery in the bank.

11. A method for managing a bank of batteries, comprising the steps of:
electrically coupling a plurality of batteries in series, forming the bank of batteries, such that—
a first battery is electrically coupled in an anode end position of the bank,
a second battery is electrically coupled in a cathode end position of the bank, and
at least a third battery is electrically coupled in at least one middle position of the bank;
determining a cathode voltage, wherein the cathode voltage is determined by measuring across the battery in the cathode end position;
determining a reference voltage, wherein the reference voltage is determined by measuring across the battery in the at least one middle position;
comparing the cathode voltage with the reference voltage; and
electrically rearranging, if a first difference between the cathode voltage and the reference voltage is more than a predetermined amount, the batteries such that the second battery is no longer electrically coupled in the cathode end position of the bank.

12. The method of claim 11, wherein the electrically rearranging step comprises electrically coupling the plurality of batteries in series in a modified order, without changing a physical relationship of the batteries.

13. The method of claim 11, wherein the electrically rearranging step comprises electrically coupling the plurality of batteries in series such that—
the third battery is electrically coupled in the anode end position of the bank,
the first battery is electrically coupled in the cathode end position of the bank, and
the second battery is electrically coupled in the middle position of the bank;

14. The method of claim 11, wherein the electrically rearranging step comprises electrically coupling the plurality of batteries in series such that—
the second battery is electrically coupled in the anode end position of the bank,
the third battery is electrically coupled in the cathode end position of the bank, and
the first battery is electrically coupled in the middle position of the bank;

15. The method of claim 11, wherein determining the reference voltage comprises measuring across each of a plurality of batteries in middle positions of the bank and averaging these measured voltages.

16. The method of claim 11, wherein the determining steps are performed periodically.

17. The method of claim 11, wherein the determining steps are performed when a voltage reduction across the bank is detected.

18. The method of claim 11, wherein the electrically rearranging step comprises electrically removing the second battery from the bank.

19. The method of claim 11, wherein the electrically rearranging step comprises electrically coupling a fourth battery in the bank.

20. A method for managing a bank of batteries, comprising the steps of:
electrically coupling a plurality of batteries in series, forming the bank of batteries, such that—
a first battery is electrically coupled in an anode end position of the bank,
a second battery is electrically coupled in a cathode end position of the bank,
a third battery is electrically coupled in a first middle position of the bank, and
a fourth battery is electrically coupled in a second middle position of the bank;
determining an anode voltage, wherein the anode voltage is determined by measuring across the first battery;
determining a reference voltage, wherein the reference voltage is determined by measuring across the third and fourth battery;
comparing the anode voltage with the reference voltage;
electrically rearranging, if a first difference between the anode voltage and the reference voltage is more than a predetermined amount, the batteries such that the first battery is no longer electrically coupled in the anode end position of the bank;
determining a cathode voltage, wherein the cathode voltage is determined by measuring across the battery in the cathode end position;
comparing the cathode voltage with the reference voltage; and
electrically rearranging, if a second difference between the cathode voltage and the reference voltage is more than a predetermined amount, the batteries such that the second battery is no longer electrically coupled in the cathode end position of the bank.
